(19) United States
(12) Patent Application Publication
(10) Pub. No.: US 2017/0233094 A1
(43) Pub. Date: Aug. 17, 2017

(54) COMPRESSIVE WIRELESS SENSING FOR ROTOR LOADS AND MOTION

(71) Applicant: SIKORSKY AIRCRAFT CORPORATION, Stratford, CT (US)

(72) Inventors: Yiqing Lin, Glastonbury, CT (US); Sanjay Bajekal, Simsbury, CT (US); Andrezej Banaszuk, Simsbury, CT (US)

(73) Assignee: Sikorsky Aircraft Corporation, Stratford, CT (US)

(21) Appl. No.: 15/518,689

(22) PCT Filed: Oct. 21, 2015
(86) PCT No.: PCT/US2015/056691

§ 371 Date: Apr. 12, 2017

Related U.S. Application Data
(60) Provisional application No. 62/066,664, filed on Oct. 21, 2014.

(51) Int. Cl. B64D 45/00; B64C 27/06; H04L 29/08

(52) U.S. Cl. CPC B64D 45/00; H04L 67/12; B64C 27/06; B64D 2045/0085

(57) ABSTRACT

A system for sensing data in an aircraft, includes a plurality of wireless sensors, a receiver to sample a random subset of the plurality of wireless sensors at each of a plurality of times to generate a data matrix with a plurality of sampled entries and a plurality of missing entries, and an analysis unit to analyze the data matrix to provide a plurality of solutions corresponding to the plurality of missing entries using numerical analysis.

### FIELD OF THE INVENTION

The subject matter disclosed herein relates to sensing data in an aircraft, and to a system and a method for generating missing entries from a random subset of sensors at each of a plurality of times.

### DESCRIPTION OF RELATED ART

Typically, in flight parameters for an aircraft, e.g. a helicopter, are desired to be monitored and reviewed. For example, important rotor systems loads and motions including blade flap, blade pitch, blade lead lag, main rotor shaft bending, main rotor shaft torque, and pitch rod loads are desired to be monitored and analyzed. Further, knowledge of helicopter rotor system loads and motion enables usage-based maintenance, life-improving control, structural health monitoring, aircraft vibration control, and individual blade control.

Wireless sensor networks are often utilized to provide data regarding in flight parameters. These wireless sensor networks traditionally attempt to collect all sensor data at desired sampling rates. These solutions do not provide for resource constraints, such as energy storage at sensor nodes and communication bandwidth of the wireless sensor network. A system and method that can sample a random subset of wireless sensors at each of a plurality of times and generate the missing entries is desired.

### BRIEF SUMMARY

According to an embodiment of the invention, a system for sensing data in an aircraft, includes a plurality of wireless sensors, a receiver to sample a random subset of the plurality of wireless sensors at each of a plurality of times to generate a data matrix with a plurality of sampled entries and a plurality of missing entries, and an analysis unit to analyze the data matrix to provide a plurality of solutions corresponding to the plurality of missing entries using numerical analysis.

In addition to one or more of the features described above, or as an alternative, further embodiments could include the numerical analysis is matrix completion.

In addition to one or more of the features described above, or as an alternative, further embodiments could include the numerical analysis is compressive sensing.

In addition to one or more of the features described above, or as an alternative, further embodiments could include the plurality of wireless sensors disposed on a rotating component of the aircraft.

In addition to one or more of the features described above, or as an alternative, further embodiments could include the rotating component including at least one of rotor blades, a rotor shaft, a hub, and a swash plate.

In addition to one or more of the features described above, or as an alternative, further embodiments could include the plurality of wireless sensors sensing at least one of load and motion characteristics.

In addition to one or more of the features described above, or as an alternative, further embodiments could include the loads and motion characteristics including at least one of blade flap, blade pitch, blade lead lag, main rotor shaft bending, main rotor shaft torque, and pitch rod loads.

According to another embodiment of the invention, a method for sensing data in an aircraft, includes providing a plurality of wireless sensors, sampling a random subset of the plurality of wireless sensors at each of a plurality of times to generate a data matrix with a plurality of sampled entries and a plurality of missing entries, analyzing the data matrix using numerical analysis and generating a plurality of solutions corresponding to the plurality of missing entries.

In addition to one or more of the features described above, or as an alternative, further embodiments could include storing the data matrix.

In addition to one or more of the features described above, or as an alternative, further embodiments could include the numerical analysis is matrix completion.

In addition to one or more of the features described above, or as an alternative, further embodiments could include the numerical analysis is compressive sensing.

In addition to one or more of the features described above, or as an alternative, further embodiments could include the analysis unit disposed outside of the aircraft.

In addition to one or more of the features described above, or as an alternative, further embodiments could include plurality of wireless sensors disposed on a rotating component of the aircraft.

In addition to one or more of the features described above, or as an alternative, further embodiments could include the rotating component including at least one of rotor blades, a rotor shaft, a hub, and a swash plate.

Technical function of the embodiments described above includes sampling a random subset of the plurality of wireless sensors at each of a plurality of times, and analyzing the data matrix using numerical analysis and generating a plurality of solutions corresponding to the plurality of missing entries.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a schematic side view of an aircraft in accordance with an embodiment of the invention;

FIG. 2 illustrates a data matrix structure in accordance with an embodiment of the invention; and

FIG. 3 is a flow diagram of a method of reconstructing sensor data in accordance with an embodiment of the invention.

### DETAILED DESCRIPTION OF THE INVENTION

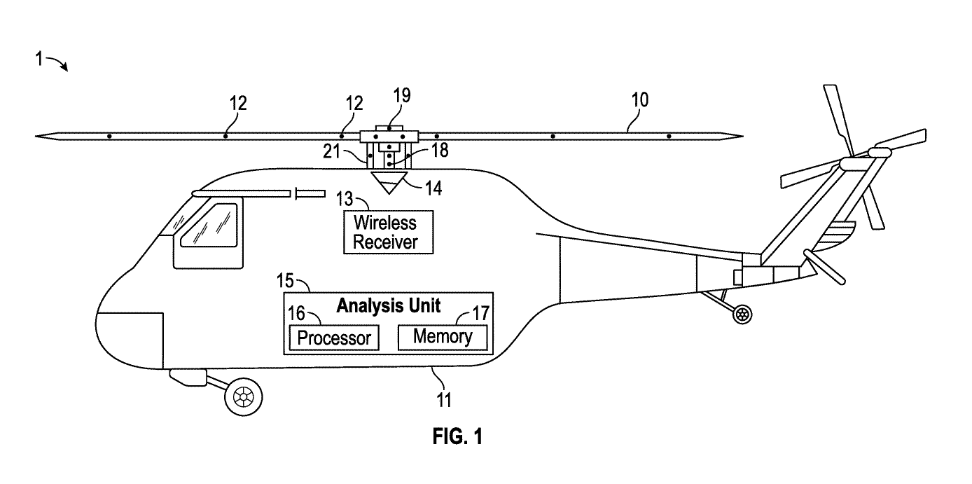

FIG. 1 illustrates general views of an exemplary aircraft in the form of aircraft 1 according to an embodiment of the invention. As illustrated in FIG. 1, the aircraft 1 may include a body 11 with rotor blades 10 with sensors 12. A plurality of rotor blades 10 is attached to a rotor hub 19. Rotor hub 19 is connected to body 11 via rotor shaft 18 and swashplate 21. Although aircraft 1 includes a swashplate, it is understood that embodiments may be utilized with aircraft lacking a swashplate. The plurality of rotor blades 10 is driven to rotate about the rotor hub 19. Although a particular configuration of an aircraft 1 is illustrated and described in the disclosed embodiments, it will be appreciated that other configurations and/or machines that may operate in land or water including fixed wing aircraft, dual rotor aircraft and rotary-wing aircraft may benefit from embodiments disclosed.

Sensors 12 may monitor aircraft 1. In an exemplary embodiment, a plurality of sensors 12 are disposed in aircraft components, including, but not limited to the rotor blades 10, the rotor shaft 18, the rotor hub 19, and the swashplate 21. The sensors 12 may include, for example, strain gauges, magnetic Hall Effect sensors, temperature sensors, pressure sensors, magnetorestrictive sensors, accelerometers, and rate gyros. The sensors 12 monitor aircraft components, including, but not limited to, the rotor blades 10, shaft 18, rotor hub 19, and swashplate 21 to sense the loads and motion of the aircraft components, including, but not limited to, rotor blades 10, shaft 18, rotor hub 19, and swashplate 21, and the effect of perturbations in the aircraft state on the aircraft components, including, but not limited to, rotor blades 10, shaft 18, rotor hub 19, and swashplate 21. In the present specification and claims, perturbations in aircraft state result in changes in the loads and motion characteristics of the aircraft components, including, but not limited to, rotor blades 10, shaft 18, rotor hub 19, and swashplate 21 including changes in blade flap, blade pitch, blade lead lag, main rotor shaft bending, main rotor shaft torque, and pitch rod loads, for example.

In certain applications, sensors 12 are subject to bandwidth and energy constraints. In these applications, it may be desirable to conserve wireless sensor network bandwidth and sensor node 12 energy usage. Accordingly, in exemplary embodiments, sensors 12 are randomly selected to acquire and transmit data. Randomly selecting sensors reduces the consumption of wireless sensor network resources such as data communication bandwidth and energy storage at sensor nodes 12 while still meeting sensing rate requirements. In exemplary embodiments, the sensor data that is not included in the randomly selected subset of sensors 12 at any given time instance will be reconstructed with advanced mathematical models. The mathematical models exploit spatial and temporal correlation among the set of sensor data. The sensors 12 may include wireless transmitters to transmit data wireles sly to an antenna 14 and receiver 13.

The receiver 13 transmits the sensed data (e.g., rotor data) to an analysis unit 15, which includes a processor 16 to process the sensed data to reconstruct missing data entries to accurately determine the loads and motion of the rotor blades 10. The analysis unit 15 may further include memory 17, supporting logic, and other circuitry necessary to analyze the sensor data and store and transmit the analyzed data. Examples of memory and supporting logic include hard disks, flash memory, volatile and non-volatile memory, field programmable gate arrays, multiplexers, and other memory and logic circuitry. According to one embodiment, the analysis unit 15 is located within the body 11 of the helicopter. In an alternative embodiment, the analysis unit 15 is external to the helicopter. For example, the wireless receiver 13 may include a wireless transmitter, and the wireless transmitter may transmit the sensor data to an external analysis unit.

According to embodiments of the present invention, sensor data from the sensors 12 may be analyzed by the analysis unit 15 using numerical analysis for low-rank matrices to provide the intentionally omitted data. In other embodiments of the present invention, analysis unit 15 uses other numerical analysis methods, such as compressive sensing (also referred to as L1-regularization) to recover the intentionally omitted data.

In an exemplary embodiment, particular conditions allow for the use of numerical analysis for low-rank matrices to be desired. In certain embodiments, in systems having a rotating component, such as the rotor blades 10 and shaft 18 of the helicopter, the data from the sensors in a rotating component is periodic. For example, the sensor data between one revolution and the next of the rotor blades 10 should be very similar if the state of the aircraft has not changed significantly. Further, in certain embodiments, sensor outputs in the rotor system of a helicopter are correlated with each other. For example, when the pitch of the rotor blades 10 is changed as a result of a pilot-initiated change in collective position, the output of the sensors will correlate with each other in the sense that the change in loads and motion induced by the change in collective is repeatable under any condition within the linear regime and proportional to the magnitude of the change in collective. In an exemplary embodiment, there is a large quantity of data gathered from multiple sensors over the sampling period. In certain embodiments, under a suitably broad range of flight conditions (e.g., a linear regime) the relationship between the state of the aircraft and the rotor loads and motion is a linear relationship.

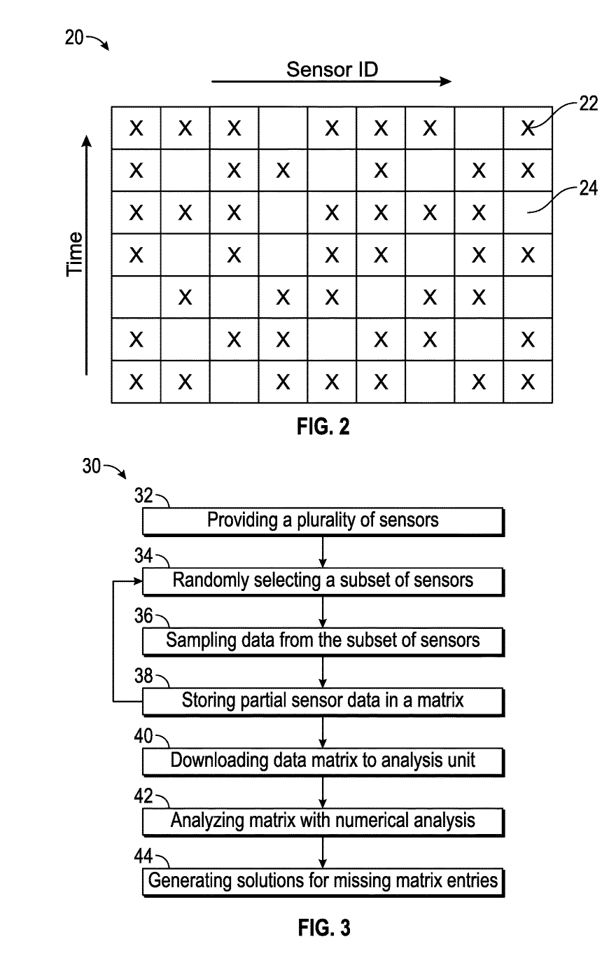

In other embodiments, particular conditions allow for the use of compressive sensing (L1-regularization) to be desired. In certain embodiments, the sparsity of sensor data in a frequency domain enables compressive sensing (L1-regularization) to be performed. In exemplary embodiments, if each column of the matrix 20 (FIG. 2), which represent data from each sensor, can be transformed into discrete cosine transform (DCT) domain and represented by a few dominant coefficients (sparse in the DCT domain), compressive sensing may be desired. Further, compressive sensing is desired if multiple sensor data points of matrix 20 display joint sparsity properties, i.e., their leading dominant coefficients have the same supports (location of non-zero components).

In certain embodiments, the nature of the loads and motion matrix enables numerical techniques. The use of these analysis methods may enable usage-based maintenance, life-improving control, structural health monitoring, aircraft vibration control, and individual blade control.

As illustrated in FIG. 2, the data received from the sensors 12 at each time forms a data matrix 20 for a given amount of time. Each row of the matrix 20 contains all of the loads and motion data for a given time that is received from the subset of sensors randomly selected, shown as sampled entries 22. Each row of matrix 20 may further contain missing entries 24 from sensors 12 not randomly selected at the same selected time. Accordingly, in certain embodiments, different rows of matrix 20 may contain different combinations of sampled entries 22 and missing entries 24. In certain embodiments, the data matrix 20 has a rank that is low, provided there is a higher sample rate (times of sampling) relative to the number of columns (number of sensors 12). In other embodiments, the data matrix 20 has sparse sensor 12 data in a frequency domain.

According to embodiments of the present invention, the analysis unit 15 may be configured to receive from the receiver 13 sensor data, and may be configured to apply one or more numerical methods upon the received sensor data matrix 20 to estimate the rotor loads and motion in the missing entries 24. In particular, the analysis unit 15 may perform one or more of compressive sensing, principal component pursuit, matrix completion, nuclear-norm regularized multivariate linear regression, and other methods to provide missing sensor data.

In exemplary embodiments, matrix completion is used to reconstruct missing entries 24 of a load or motion matrix 20. In other embodiments, compressive sensing (L1-regularization) is used to reconstruct missing entries 24 of a load or motion matrix 20. This may become an important task since data is intentionally omitted to limit resource utilization.

FIG. 3 is a flow diagram of a method 30 of reconstructing sensor data according to an embodiment of the present invention. Although one particular sequence of operations is illustrated, embodiments of the present invention also correspond to methods in which the operations are performed in an alternative order, in which one or more operations are omitted, or in which alternative operations are added or substituted in the method.

In operation 32, a plurality of sensors is provided. The plurality of sensors 12 can be positioned on aircraft components, including, but not limited to a rotor blade 10, shaft 18, hub 19, and swashplate 21 of a helicopter.

In operation 34, a random subset of sensors is selected from the plurality of sensors. Selecting a random subset of the available sensors reduces the usage of data communication bandwidth and energy at sensor nodes 12. In certain embodiments, the sensors 12 are self selected randomly to be part of the current subset of sensors 12. In other embodiments, a central device, such as wireless receiver 13 or analysis unit 15 randomly selects the subset of sensors 12. In certain embodiments, the random sampling rate is predetermined and fixed for a given time period. In exemplary embodiments, any suitable percentage of sensor data (such as 20%) is randomly selected and sampled.

In operation 36, data is sampled from the randomly selected subset of sensors. In an exemplary embodiment, the data sampled corresponds to aircraft components, including, but not limited to, rotor blade 10, shaft 18, hub 19, and swashplate 21 of a helicopter.

In operation 38 the data from the subset of sensors, including the missing entries from the sensors not included in the subset of sensors selected at a given time is stored in a matrix. In an exemplary embodiment, each subsequent sampling operation 36 may append data to the matrix. In an exemplary embodiment, operations 34, 36, and 38 may be performed repeatedly to collect the desired in flight parameters and data. Accordingly, after a subset of sensors is randomly selected, sampled, and the data recorded in the matrix, another subset of sensors may be randomly selected to repeat the data collection and recording process until data acquisition is completed.

In operation 40 the matrix is transferred to an analysis unit on board the aircraft or to an analysis unit external to the aircraft. In an exemplary embodiment of operation 42, numerical analysis for a low-rank matrix is performed, including one or more of principal component pursuit, matrix completion, and nuclear-norm regularized multivariate linear regression. In other embodiments of operation 42, numerical analysis for a sparse domain matrix is performed, including compressive sensing (L1-regularization).

In operation 44, the results of the numerical analysis are used to estimate sensor data that corresponds closely to actual data, such as actual loads and motion characteristics of the aircraft components, including but not limited to, rotor blade 10, shaft 18, hub 19, and swashplate 21. The numerical methods may provide missing sensor data and may provide the estimated or reconstructed sensor data. The numerical methods may further estimate unmeasured loads and motion from the state of the aircraft or from other measured loads and motion.

In certain embodiments the data from the numerical analysis, including the reconstructed loads and motion data, is used to improve operation of the helicopter, such as by isolating sensor faults, isolating structural faults, or monitoring structural usage of components, such as rotor blade 10, shaft 18, hub 19, and swashplate 21, etc.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. For instance, aspects of the invention are not limited to propeller blades for aircraft, and can be used in wind turbines and other systems with rotary elements. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A system for sensing data in an aircraft, comprising:
a plurality of wireless sensors;
a receiver to sample a random subset of the plurality of wireless sensors at each of a plurality of times to generate a data matrix with a plurality of sampled entries and a plurality of missing entries; and
an analysis unit to analyze the data matrix to provide a plurality of solutions corresponding to the plurality of missing entries using numerical analysis.

2. The system of claim 1, wherein the numerical analysis is matrix completion.

3. The system of claim 1, wherein the numerical analysis is compressive sensing.

4. The system of claim 1, wherein the plurality of wireless sensors are disposed on a rotating component of the aircraft.

5. The system of claim 4, wherein the rotating component includes at least one of rotor blades, a rotor shaft, a hub, and a swash plate.

6. The system of claim 1, wherein the plurality of wireless sensors sense at least one of load and motion characteristics.

7. The system of claim 6, wherein the loads and motion characteristics include at least one of blade flap, blade pitch, blade lead lag, main rotor shaft bending, main rotor shaft torque, and pitch rod loads.

8. A method for sensing data in an aircraft, comprising:
providing a plurality of wireless sensors;
sampling a random subset of the plurality of wireless sensors at each of a plurality of times to generate a data matrix with a plurality of sampled entries and a plurality of missing entries;
analyzing the data matrix using numerical analysis; and
generating a plurality of solutions corresponding to the plurality of missing entries.

9. The method of claim 8, further comprising storing the data matrix.

10. The method of claim 8, wherein the numerical analysis is matrix completion.

11. The method of claim 8, wherein the numerical analysis is compressive sensing.

12. The method of claim 8, wherein the plurality of wireless sensors are disposed on a rotating component of the aircraft.

13. The method of claim 12, wherein the rotating component includes at least one of rotor blades, a rotor shaft, a hub, and a swash plate.

14. The method of claim 8, wherein the plurality of wireless sensors sense at least one of load and motion characteristics.

15. The method of claim 14, wherein the loads and motion characteristics include at least one of blade flap, blade pitch, blade lead lag, main rotor shaft bending, main rotor shaft torque, and pitch rod loads.
